(19) United States
(12) Patent Application Publication
(10) Pub. No.: US 2011/0191448 A1
(43) Pub. Date: Aug. 4, 2011

(54) Subdivision of Media Streams for Channel Switching

(76) Inventors: Thomas Rusert, Kista (SE); Jörg Huschke, Aachen (DE); Markus Kampmann, Aachen (DE)

(21) Appl. No.: 13/058,432

(22) PCT Filed: Aug. 12, 2008
(86) PCT No.: PCT/EP08/60590

§ 371 Date: Mar. 14, 2011

(51) Int. Cl. G06F 15/16

(52) U.S. Cl. 709/219

(57) ABSTRACT

The invention provides the possibility of fast channel switching by subdividing N media streams, each media stream representing a channel, into a stream bundle containing for each channel a more important part of the media stream comprising the parts of the media stream considered more important in view of a quality of experience representing an expected quality perception of a user, and into N less important parts

### TECHNICAL FIELD

This invention relates to a method for sending N media streams, each media stream representing a channel, to a user entity, to a method for receiving a media stream by the user entity, to a transmitter sending the N media streams and to a receiver receiving a media stream.

### BACKGROUND

In digital multicast and broadcast TV delivery systems, such as in IPTV, Internet TV, or Mobile TV over e.g. DVB-H or 3GPP MBMS, each TV channel is represented by a media stream comprising compressed audio and video. One example of a compression technique is the MPEG compression (Moving Picture Experts Group) in which the concept of a group of pictures (GOP) layer is used, the GOP layer containing a small number of frames, such as I frames, P frames or B frames. The video is typically coded using predictive coding techniques. Here, so-called I pictures allow for instantaneous decoding, since they have no dependencies on previously encoded pictures. In contrast, so-called P-pictures (predictively coded pictures), are encoded using previously encoded I or P pictures as references. For the transmission of media streams often compression techniques are used.

Multicast/broadcast systems typically do not allow for retransmissions in case of transmission errors. To increase the robustness against transmission errors in such systems, application layer forward error correction techniques (AL-FEC) can be used. An example for AL-FEC is Raptor coding as used in 3GPP MBMS (3GPP TS 26.346: Technical Specification Group Services and System Aspects; Multimedia Broadcast/Multicast Service (MBMS); Protocols and codecs (Release 7)). AL-FEC might also be applied in IPTV and Internet TV such as to improve reliability against packet losses.

The AL-FEC information is generated at the transmitter side, and represented by so-called repair packets (RPs). Each RP corresponds to a so-called source block (SB), each of which comprising media packets from one or multiple media streams. For example, the media packets corresponding to a single Mobile TV or IPTV channel might be subdivided into a sequence of source blocks, each of them e.g. corresponding to 2 seconds of media stream. Then the AL-FEC encoder at the transmitter generates RPs for each of the SBs, and for each SB, the SB packets as well as the corresponding RPs are transmitted. Both SB packets and RPs might get lost due to transmission errors.

At the receiver side, if parts of a transmitted SB should be lost due to transmission errors, those parts might be recovered by the AL-FEC decoder by using the received parts of the SB and the received RPs that correspond to that SB. In order to successfully recover SBs in case of transmission errors, a sufficient number of RPs needs to be available at the receiver. In case the number of received RPs is too small to compensate for the lost SB packets, the transmission errors in that SB cannot be corrected.

To maximize the probability that a SB can be recovered in case of transmission errors, the receiver needs to receive as many as possible of the transmitted RPs corresponding to the SB. Thus only after the complete SB and all corresponding RPs have been transmitted to the receiver, the AL-FEC decoder should try to recover possible SB packet losses. After AL-FEC decoding, the SB can be forwarded to the media player at the receiver.

To enable seamless error correction and thus continuous play-out in case of transmission errors, the receiving side needs to use a receiving AL-FEC decoding buffer buffering as much data as the largest possible SB and the corresponding RPs may comprise. This ensures that in case of transmission errors, all SB data and repair information corresponding to the SB can be used by the AL-FEC decoder. Upon tuning into a new channel, the receiving AL-FEC decoding buffer has to be filled before the first SB can be forwarded to the media player. The time required to refill the buffer depends on the maximum SB length. It has a direct impact on the time until the media playout can be started, which is denoted as the channel switching time.

As of the burst nature of transmission errors in typical multicast/broadcast systems, it is advantageous that a SB is large. This obviously contradicts with the desire to have short channel switching time. As a compromise, a SB in a Mobile TV, IPTV, or Internet TV system might cover 2 seconds of a media stream.

One possible solution to reduce the channel switching time when AL-FEC is used would be to use stream bundling. When stream bundling is used, multiple media streams are combined before the SBs are constructed, i.e. each SB comprises media packets corresponding to different media streams. A set of media streams combined in such a way are denoted as a stream bundle. If stream bundling is used, the receiver receives all media streams in the bundle simultaneously. Thus if a channel switch is requested to a channel in the same stream bundle, then no rebuffering is needed, which significantly reduces the channel switching time. If a channel switch is requested to a channel that is contained in a stream bundle other than the currently received bundle, the AL-FEC decoding buffer refill problem and thus the channel switching problem remains. Another advantage of using stream bundling in systems where constant bit rate channels are used (e.g. in wireless broadcast) is that so-called statistical multiplexing can be done. Here, instead of allocating a constant bit rate for each channel, the bundled channels are transmitted over only one channel. Although this channel would still be a constant bit rate channels, the bit rate could be distributed among the bundled streams according to the content-dependent bit rate requirements for each of the media streams, thus utilizing the available bandwidth more efficiently.

Considering only channel switching time without considering bandwidth requirements and receiver complexity, it would be desired to use stream bundling over all available media. However this would require significantly increased processing power at the receiver, since all media streams would have to be received simultaneously, although only one of them is consumed. For example, in an MBMS-based Mobile TV system, the number of channels could be typically N=5, and each of them is transmitted at a bit rate of R. N might be even higher in other Mobile TV systems. If stream bundling would be used over the N channels, the bit rate at which the terminal would have receive and process media data would be N times the bit rate that the terminal would have to receive without stream bundling. With stream bundling, the terminal would be much more complex in terms of processing power, memory requirements, and battery consumption. For an multicast-based IPTV or Internet TV system, the number of channels could be N=30 or higher. Especially if HD TV content is transmitted, the bandwidth available on the last hop to the terminal (e.g. a DSL connection) could be too small, such that it would not be possible to transmit a stream bundle comprising all N streams.

### SUMMARY

Accordingly, a need exists to allow for fast channel switching and to keep the complexity of the receiver low.

This need is met by the features of the independent claims. In the dependent claims preferred embodiments of the invention are described.

According to a first aspect of the invention, a method is provided for sending N media streams, each media stream representing a channel, to a user entity, wherein the media stream of each channel is subdivided into a more important part (MIP) comprising the parts of the media stream considered more important in terms of user perception and into a less important part (LIP) including the remaining information of the media stream. More important in terms of user perception means that it is more important in terms of its contribution to the media stream quality perceived by a user. The more important part may comprise those parts of a media stream that are most important in terms of user perception when the media is decoded, whereas the less important part contains the remaining information of the media stream. In an additional step the more important parts of the N channels are combined to a stream bundle and the stream bundle and the less important parts are sent to the user entity separately. By the fact of combining the N MIPs to a stream bundle a fast channel switching is possible. At the same time the complexity caused by the bundling of complete media streams as well as the bandwidth requirements for a transmission of the stream bundle can be reduced by subdividing the media stream into the more important part (MIP) and the less important part (LIP). By way of example in a media stream the MIP could comprise only the audio packets of the media stream, whereas the LIP may comprise the video stream. As another example, the MIP may include the audio packets and some of the I frames in the video stream, while the LIP could comprise the remaining I frames and P frames.

In another embodiment the MIP may comprise a base layer, whereas the LIP comprises the enhancement layer when scalable coding techniques are used.

Preferably, the N less important parts of the N channels are transmitted separately for each media stream, i.e. the LIPs are not bundled. Thus, in total for N media streams N+1 flows are transmitted, one of them carrying the bundled MIPs of the N media streams and the remaining N flows containing the LIP for each media stream, respectively.

Preferably, the stream bundle of the more important parts and the less important parts of the N channels have a different level of protection of an error protection scheme. By way of example the stream bundle may be protected using the AL-FEC protection technique discussed in the introductory part of the description. The LIPs might not be AL-FEC-protected. However, it is also possible that both parts, MIPs and LIPs, have the same level of protection. In this embodiment each LIP may also be AL-FEC-protected with the same or different level of protection. In case the AL-FEC technique is used for the MIP, the bundled MIPs are transmitted along with the corresponding repair packets RP. In case the remaining N flows of LIPs are protected using the AL-FEC technique, each flow additionally contains the repair packets of the respective LIP.

According to another aspect of the invention, a method for receiving the media stream by the user entity is provided, the method comprising the step of receiving the stream bundle containing the N more important parts of the N media streams, each media stream representing a channel, the media stream of each channel being subdivided into the MIP and the LIP as discussed above. Furthermore, the more important part of a selected channel is extracted from the stream bundle and the less important part of the media stream corresponding to the same media stream as the extracted more important part is received. With the MIP and the LIP of the selected channel it is possible to merge the extracted MIP and the received LIP of the selected channel for playout. Accordingly, only two data streams are received and decoded, the stream bundle comprising all MIPs and the LIP of a selected channel. With this reception situation it is possible to immediately play out a new channel in case of a channel switching request made by the user of the user entity. Preferably, upon a request for a channel switch to a new channel the more important part of the new channel is extracted from the stream bundle and the reception of the less important part is switched to the reception of the less important part of the new channel. Thus, when one channel is consumed and a channel switch is requested, the terminal can immediately play out at least the MIP of the new media stream by extracting the MIP from the stream bundle, Since the data that is needed to do so is already available in the received stream bundle at the same time it starts receiving the LIP of the new media stream. The way how the new channel is played out depends in the beginning on the fact whether the LIP of the new channel is error-protected or not. In case no error protection scheme is used for the LIP of the new channel, the new channel can be played out using the MIP and the LIP of said new channel immediately after the channel switch request.

In case the less important part of the new channel is protected using an error protection scheme, such as the AL-FEC technique, the new channel is played out using the MIP of the new channel while a decoding buffer present in the decoder of the receiver is filled with the less important part of said new channel. When the decoding buffer is filled with the LIPs of the new channel up to a predetermined level, the new channel can be played out using the MIP and the LIP of the new channel. This means that when the LIPs of the different channels are not error-protected any channel switching delay induced by a decoding of an error protection scheme is avoided. In case an error protection scheme is used for the LIPs, the media stream may be played out at the beginning using only the MIP part until a decoding buffer for the LIPs is filled with the LIPs of the new channel.

The invention furthermore relates to a transmitter sending the N media streams, each media stream representing a channel, to the user entity, the transmitter comprising at least one stream splitter subdividing the media stream of each channel into the MIP and the LIP. Further, a bundle generating unit is provided combining the N more important parts of the N channels to a stream bundle, the transmitter sending the stream bundle and the N less important parts to the user entity. The transmitter may act as described above and may send the N less important parts separately.

In total, the transmitter sends N+1 flows in the case of N channels, one flow representing the stream bundle and the N flows containing the LIP for each channel. Additionally, at least one encoding unit may be provided carrying out a different level of protection of an error protection scheme for the stream bundle and the N less important parts. When the encoding unit carries out an error protection encoding scheme such as the AL-FEC technique and when no error protection scheme is applied to the LIPs, then a seamless switching from one channel to another channel is possible.

According to another aspect a receiver for receiving the media stream is provided, the receiver receiving the stream bundle containing the N MIPs. The receiver comprises an extracting unit extracting the MIP of a selected channel from the stream bundle. Furthermore, the receiver is configured so as to select for reception the less important part of a media stream corresponding to the same media stream as the extracted MIP. Furthermore, a stream merging unit is provided merging the extracted MIP and the received LIP of the selected channel for playout. The receiver works as described above with reference to the way of receiving the media streams as explained in detail above.

### BRIEF DESCRIPTION OF THE DRAWINGS

In following the invention will be described in further detail with reference to the accompanying drawings.

FIG. 1 is a schematic block diagram showing how a media stream is delivered to a user entity,

FIG. 2 shows a transmitter sending N equal 2 media streams, each media stream representing a channel, using the separation of the media streams into a more important part and a less important part,

FIG. 3 shows a receiver receiving the media streams transmitted from the transmitter, and

FIG. 4 shows a flowchart of a channel switch from one channel to another channel.

### DETAILED DESCRIPTION

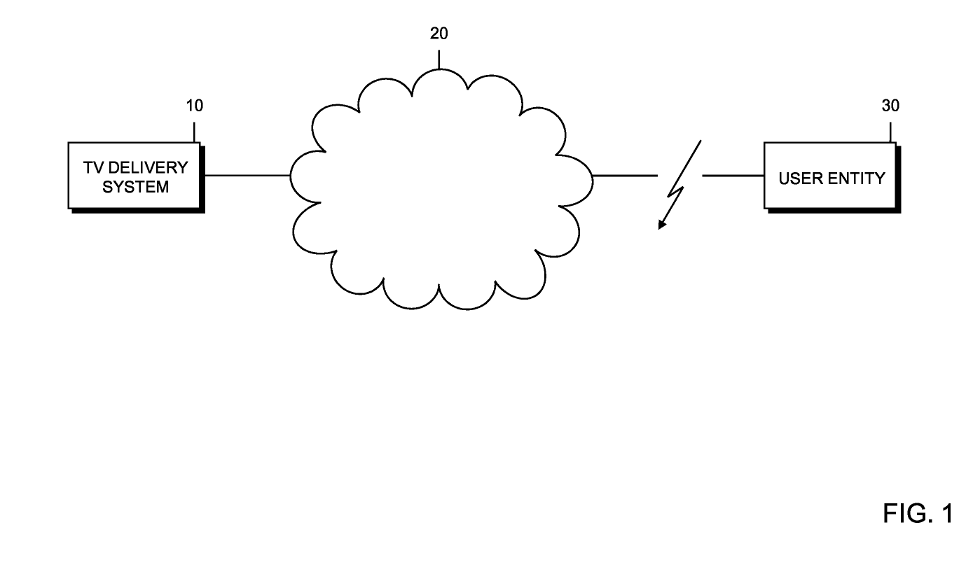

In FIG. 1 a system is shown allowing to transmit N channels of media streams to a user entity, N being equal or greater than 2. A TV delivering system can provide the digital multicast or broadcast media streams that are transmitted over the network 20 to the user entity 30. The user entity 30 may be a mobile phone or any other mobile communication unit that is able to wirelessly connect to the network 20. Network 20 may contain different networks, such as the internet and a cellular network with which the media streams are transmitted to the user entity. The N channels may be transmitted to the user entity in a wireless way as shown, however it is also possible to transmit the channels using a wired connection, e.g. in case of IP-TV.

To enable fast channel switching between N media streams while using AL-FEC, it is proposed to subdivide each media stream into two parts, the more important part (MIP) and the less important part (LIP). The MIP comprises those parts of a media stream that are most important in terms of user perception when the media is decoded and presented, i.e. in view of a quality of experience representing an expected quality perception of the user, and the LIP is the remaining information comprising the media stream. For example, the MIP could comprise only the audio packets corresponding to the media stream, while the LIP would comprise the video stream. As another example, the MIP can include the audio packets, and some of the I frames in the video stream, while the LIP would comprise the remaining I frames and the P frames.

Given a subdivision of each media stream into MIP and LIP, the N resulting MIPs are combined into one stream bundle (MIP bundle), which is protected using AL-FEC. The LIP is transmitted separately for each media stream, i.e. the LIPs are not bundled.

Each LIP might be AL-FEC protected separately, however the strength of AL-FEC protection could be lower as for the MIP bundle, or it would also be possible not to use AL-FEC for the LIPs, so as to reduce the required bit rate. This way, the MIPs would be better protected against transmission errors as compared to the LIPs, such as to reflect the difference in importance of MIPs and LIPs.

The mode of operation where FEC is used, and the strength of protection for certain less important information is not the same as the strength of protection for certain more important information is similarly known as unequal error protection (UEP). However UEP alone, given the fact that it uses FEC, exhibits the problem that it requires a FEC decoding buffer, and thus induces the same problem as with other FEC-based systems regarding channel switching (as described above). One aspect of the present invention is that the MIPs of the media streams are bundled so that fast channel switching is enabled. The protection for the MIP bundle might be different from the protection for each LIP, but it might also be the same. The advantage of using AL-FEC only on the MIP bundle but not on the LIPs is that while this scheme protects the most important information of the media streams, it avoids any AL-FEC induced channel switching delay, neither for MIPs (since they are bundled), nor for LIPs (since they don't use AL-FEC).

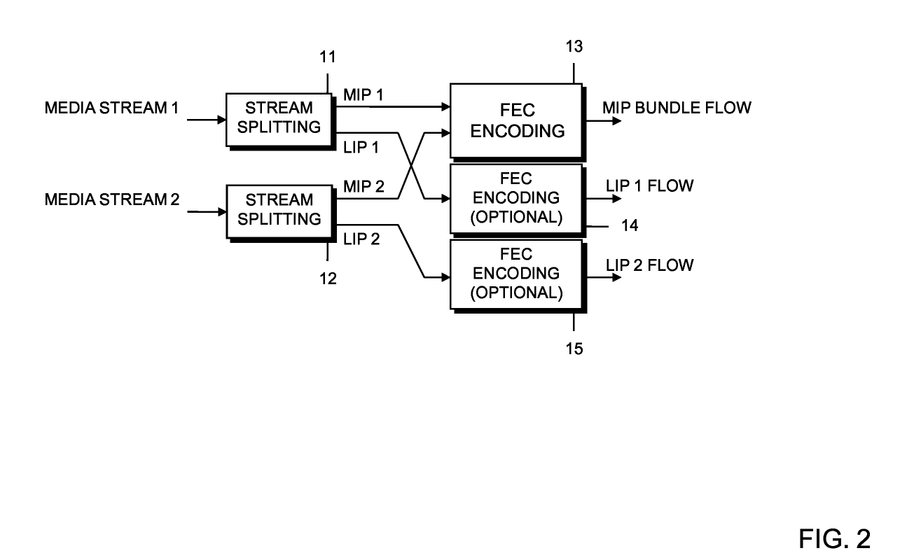

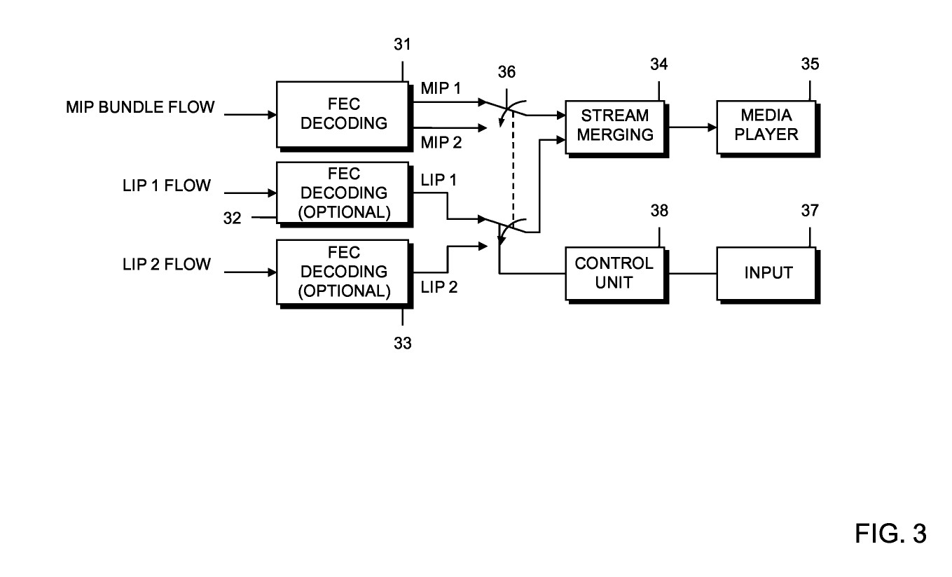

In total, for N media streams, the receiver sends N+1 data flows, one of them carrying the bundled MIPs of the N media streams along with the corresponding RPs (MIP bundle), and the remaining N flows containing LIP for one media stream each, possibly containing RPs corresponding to the respective LIP. While consuming a channel, the terminal receives two flows, the MIP bundle flow, and the flow containing the LIP of the consumed media stream. The transmitter and receiver operations are illustrated in FIG. 2 and FIG. 3, respectively, for the case of N=2 media streams.

In the embodiment shown in FIG. 2 two different channels are transmitted from the TV delivery system 10. In FIG. 2 the transmitter used in the TV delivery system is shown in more detail. A first media stream corresponding to a first channel is transmitted to a stream splitter 11, where the media stream is split into a first part, the MIP 1 comprising the part of the media stream 1 that is considered more important in view of a quality of experience representing the expected quality of perception of the user or in other words that is considered more important in view of a user perception for the user of the user entity 30. The stream splitter additionally provides the less important part LIP 1 of the first channel, LIP 1 containing the remaining information of the media stream not contained in MIP 1. The second media stream is fed to a second stream splitter 12 splitting the media stream 2 into MIP 2 and LIP 2. MIP 1 and MIP 2 are then fed to an encoding unit 13 where for increasing the robustness against the transmission errors a forward error correction (FEC) encoding technique is used. However, it should be understood that any other error protection scheme might be used or no error protection at all is used. In the embodiment shown the encoding unit 13 furthermore works as bundle generating unit combining the two MIPs to a MIP bundle flow or stream bundle from where it is sent to the receiver. Additionally, encoding units 14 and 15 may be provided for the respective LIPs.

In FIG. 3 a receiver of a user entity is shown in more detail. The MIP bundle transmitted from the transmitter shown in FIG. 2 is received by a decoding unit 31, the decoding unit comprising a decoding buffer (not shown), where the received MIP bundle flow is buffered before it is decoded. In the decoding unit 31 furthermore the MIPs of the different channels are separated and are provided at the output of unit 31 as separated MIPs, in the following example MIP 1 and MIP 2. Additionally, decoding unit 32 or 33 may be provided for the two LIP flows, the decoding units being used in case the LIP flows were encoded for transmission. Preferably, only one of the decoding units is active, namely the decoding unit decoding the LIP of the selected channel. Furthermore, only one decoding unit may be provided receiving the LIP of the selected channel.

When the user entity consumes a channel, the receiver actually receives two flows, the MIP bundle flow of the selected channel and the LIP of the selected channel. In the embodiment shown it is channel 1. MIP 1 and LIP 1 are merged in a merging unit 34 where the two parts of the media stream are combined before they are played out by media player 35. Additionally, a switch 36 is provided allowing to switch from one channel to another. In case a user wants to select another channel using input unit 37, a control unit 38 is provided that is controlling the switch 36 in such a way that the switch changes from the reception of channel 1 to channel 2. In this case the switch would have to switch from MIP 1 to MIP 2 and from LIP 1 to LIP 2.

When one channel is consumed and a channel switch is requested, the terminal can immediately play-out the MIP of the new media stream, since the data that is needed to do so is already available in the AL-FEC decoding buffer. At the same time, it starts receiving the LIP of the new media stream. If the LIP is not AL-FEC protected, the play-out of both the MIP and the LIP can start immediately. If the LIP is AL-FEC protected, then the terminal first refills the AL-FEC decoding buffer for the LIP while playing out the MIP only. Once the buffer is sufficiently filled, both MIP and LIP are played. The former case can be regarded a “clean” channel switch, i.e. if only the MIP bundle is protected, then the new channel can be played out immediately using both MIP and LIP, i.e. at full quality. The latter case would not be a “clean” channel switch, since while the AL-FEC buffer for the LIP is refilled, only MIP would be played out. The perceived quality of a temporary MIP-only playout depends on how the media streams are subdivided into MIP and LIP. It is desirable from a user's point of view that when a channel switching request is issued, an immediate response to this action can be perceived, indicating reception of the new channel. This would be e.g. be enabled if audio and possibly I frames would be included in the MIP.

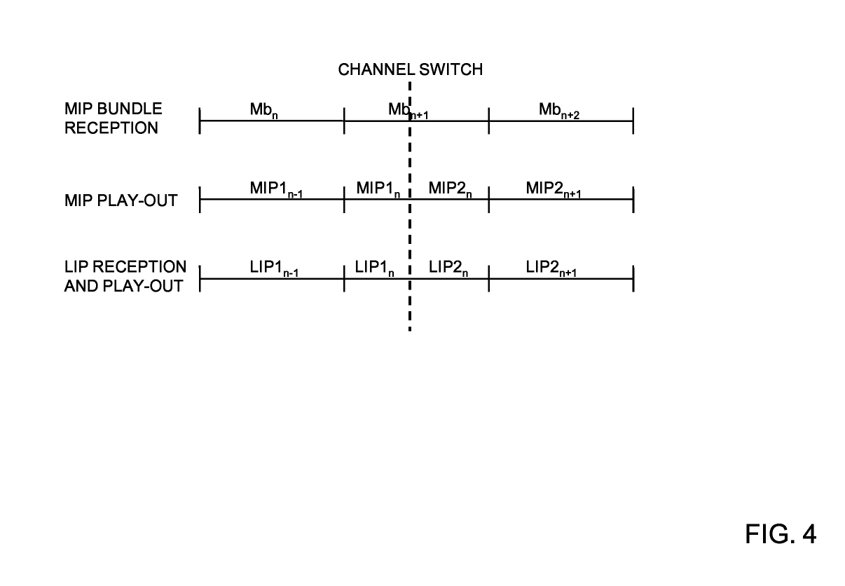

Note that if the AL-FEC decoding buffers for MIP and LIP are of different lengths, different delays are introduced. The difference in delay needs to be compensated before the media data is played out. For example, assume the MIP bundle is protected such that a 2 s buffer is required at the receiver, and the LIPs are unprotected, i.e. no AL-FEC decoding buffer is required at the receiver. Then if the transmitter sends the LIPs with 2 s delay as compared to media contained in the MIP, the end-to-end delay is the same for MIP and LIP. Reception and playout of MIPs and LIPs is illustrated in FIG. 4.

In FIG. 4 an example of a MIP and LIP reception over time is shown where a channel switch is indicated. Before the channel switch Mbn denotes reception of the MIP bundle covering SBs representing temporal instance n. MIPxn denotes play-out of temporal instance n of MIP of channel x. LIPxn denotes reception and play-out of temporal instance n of LIP of channel x. In the example, it is assumed that the LIP information is not AL-FEC protected. Thus play-out can start immediately after reception.

The scheme allows for fast channel switching through the use of stream bundling. Furthermore the beneficial effects of statistical multiplexing can be exploited within the MIP bundle. However, at the same time, the increase in complexity caused by bundling of complete media streams, as well as the bandwidth required for transmission of a bundle comprising complete media streams, can be significantly reduced. If the LIP is not AL-FEC protected, then play-out of both MIP and LIP can immediately start, while if the LIP is also AL-FEC protected, the terminal would first play-out only the MIP, and play-out both MIP and LIP once the AL-FEC decoding buffer for the LIP is refilled.

For example, if N media streams each of bit rate R are completely bundled, then bundling everything would result in a total data rate of NR. With R=R_MIP+R_LIP, let R_MIP and R_LIP be the bit rates of the MIP and LIP, and let be P=R_MIP/R the percentage of MIP relative to the total bit rate. Then the cumulated media bit rate in the MIP bundle is PNR, and the media bit rate for the LIP of one media stream is (1−P)R, i.e. the total media bit rate to be received by the terminal is PNR+(1−P)R. Relative to the bit rate of the full bundle (NR), the bit rate to be received according to the invention is P+(1−P)/N. As a typical example, assuming that the MIP comprises only the audio information, P=10%. Then for N=5, only 28% of the total bit rate has to be received. For P=10% and N=20, only 14.5% of the total bit rate has to be received.

The present invention allows for fast channel switching through the use of stream bundling. Furthermore the beneficial effects of statistical multiplexing can be exploited within the MIP bundle. At the same time, the increase in complexity caused by bundling of complete media streams, as well as the bandwidth required for transmission of a bundle comprising complete media streams, can be significantly reduced. If the LIP is not AL-FEC protected, then play-out of both MIP and LIP can immediately start, while if the LIP is also AL-FEC protected, the terminal would first play-out only the MIP, and play-out both MIP and LIP once the AL-FEC decoding buffer for the LIP is refilled.

1-17. (canceled)

18. A method for sending media streams to a user entity, each media stream representing a channel, the method comprising:
subdividing the media stream of each channel into a more important part and a less important part, the more important part comprising parts of the media stream considered more important in terms of their contribution to the quality of the media stream as perceived by a user of the user entity, and the less important part comprising the remaining information of the media stream,
combining the more important parts of different media streams into a stream bundle, and
sending the stream bundle and the corresponding less important parts to the user entity separately.

19. The method according to claim 18, wherein the corresponding less important parts are sent to the user entity separately from each other.

20. The method according to claim 18, wherein said sending comprises sending the stream bundle and the corresponding less important parts with a different level of error protection.

21. The method according to claim 18, wherein each media stream comprises a plurality of media packets, wherein the more important part of a media stream comprises media packets of the media stream considered more important to the quality of the media stream and the less important part of the media stream comprises the remaining media packets of the media stream, wherein said combining comprises combining more important media packets from different media streams into a source block, and wherein said sending comprises encoding the source block separately from any encoding associated with the less important packets.

22. A method implemented by a user entity for receiving a media stream, the method comprising:
receiving a stream bundle containing one part of each of multiple media streams that have been subdivided into two parts, including a more important part and a less important part, the more important part of a media stream contained in the stream bundle and comprising parts of the media stream considered more important in terms of their contribution to the quality of the media stream as perceived by a user of the user entity, and the less important part of a media stream not included in the stream bundle and comprising the remaining information of the media stream,
extracting from the stream bundle the more important part of a media stream corresponding to a selected channel,
receiving, separately from the stream bundle, the less important part of the media stream corresponding to the selected channel, and
merging the extracted more important part and the received less important part for playout.

23. The method according to claim 22, further comprising, upon a request for a channel switch to a new channel:
extracting from the stream bundle the more important part of the media stream corresponding to the new channel, and
receiving, separately from the stream bundle, the less important part of the media stream corresponding to the new channel.

24. The method according to claim 22, wherein, upon a request for a channel switch to a new channel:
extracting from the stream bundle the more important part of the media stream corresponding to the new channel, and
commencing playout of the new channel using at least that more important part.

25. The method according to claim 24, further comprising receiving, separately from the stream bundle, the less important part of the media stream corresponding to the new channel, wherein the less important part is not protected by an error protection scheme, and wherein said commencing comprises commencing playout of the new channel using the more important part and the less important part of the media stream corresponding to the new channel responsive to receiving the less important part.

26. The method according to claim 24, further comprising receiving, separately from the stream bundle, the less important part of the media stream corresponding to the new channel, wherein the less important part is protected by an error protection scheme, and wherein said commencing comprises:
commencing playout of the new channel using the more important part, while a decoding buffer is being filled with the less important part, and
when the decoding buffer is filled at a predetermined level, commencing playout of the new channel using both the more important part and the less important part.

27. A transmitter configured to send media streams to a user entity, each media stream representing a channel, the transmitter comprising:
at least one stream splitter configured to subdivide the media stream of each channel into a more important part and a less important part, the more important part comprising parts of the media stream considered more important in terms of their contribution to the quality of the media stream as perceived by a user, and the less important part comprising the remaining information of the media stream, and
a bundle generating unit configured to combine the more important parts of different media streams into a stream bundle,
wherein the transmitter is configured to send the stream bundle and the corresponding less important parts to the user entity separately.

28. The transmitter according to claim 27, wherein the transmitter is configured to send the corresponding less important parts separately from each other.

29. The transmitter according to claim 27, further comprising at least one encoding unit configured to protect the stream bundle and the less important parts with a different level of error protection.

30. The transmitter according to claim 27, wherein each media stream comprises a plurality of media packets, wherein the more important part of a media stream comprises media packets of the media stream considered more important to the quality of the media stream and the less important part of the media stream comprises the remaining media packets of the media stream, wherein the bundle generating unit is configured to combine more important media packets from different media streams into a source block, and wherein the transmitter is configured to encode the source block separately from any encoding associated with the less important packets.

31. A receiver configured to receive a media stream, the receiver comprising
an extracting unit configured to:
receive a stream bundle containing one part of each of multiple media streams that have been subdivided into two parts, including a more important part and a less important part, the more important part of a media stream contained in the stream bundle and comprising parts of the media stream considered more important in terms of their contribution to the quality of the media stream as perceived by a user associated with the receiver, and the less important part of a media stream not included in the stream bundle and comprising the remaining information of the media stream, and
extract from the stream bundle the more important part of the media stream corresponding to a selected channel
a control unit configured to control the receiver to selectively receive, separately from the stream bundle, the less important part of the media stream corresponding to the selected channel, and
a stream merging unit configured to merge the extracted more important part and the received less important part for playout.

32. The receiver according to claim 31, wherein, upon a request for a channel switch to a new channel, the extracting unit is configured to extract from the stream bundle the more important part of the media stream corresponding to the new channel and the control unit is configured to control the receiver to switch to receiving the less important part of the media stream corresponding to the new channel.

33. The receiver according to claim 32, wherein the less important part of the media stream corresponding to the new channel is not protected by an error protection scheme, and wherein the stream merging unit is configured to merge the more important part and the less important part of the media stream corresponding to the new channel for playout responsive to receiving the less important part.

34. The receiver according to claim 32, further comprising a media player for playout of the new channel, wherein the less important part of the media stream corresponding to the new channel is protected by an error protection scheme, wherein the receiver further comprises a decoding buffer configured to buffer that less important part, and wherein the merging unit is configured to:
provide only the more important part to the media player for playout of the new channel, without merging that more important part with the less important part, while the decoding buffer is being filled with the less important part, and
when the decoding buffer is filled at a predetermined level, merge the more important part and the less important part for playout by the media player.

35. The receiver according to claim 31, further comprising a media player and wherein, upon a request for a channel switch to a new channel, the extracting unit is configured to extract from the stream bundle the more important part of the media stream corresponding to the new channel and the media player is configured to commence playout of the new channel using at least that more important part.

36. The receiver according to claim 31, further comprising one or more decoders that are each configured to decode an error protection scheme applied to at least one of the stream bundle and a less important part of one of the media streams.
